(19) United States
(12) Patent Application Publication
(10) Pub. No.: US 2023/0100266 A1
(43) Pub. Date: Mar. 30, 2023

(54) Pacifying Personal Protective Device

(71) Applicant: Toni Jefferson, Jackson, TN (US)

(72) Inventor: Toni Jefferson, Jackson, TN (US)

(21) Appl. No.: 17/488,525

(22) Filed: Sep. 29, 2021

(51) Int. Cl. A61J 17/00; A62B 18/08; A41D 13/11

(52) U.S. Cl. CPC A61J 17/1115; A61J 17/001; A62B 18/084; A62B 18/086; A41D 13/11

(57) ABSTRACT

A pacifying personal protective device for a child includes a panel, which is attachable to a head of a child so that the panel is positioned over at least a mouth and a nose of the child. The panel reduces transmission of pathogens between the child and persons proximate to the child. A pacifying element is engaged to the panel and is positioned proximate to the mouth of the child. The pacifying element facilitates pacification of the child, thus increasing a likelihood that the panel will remain in position on the head of the child.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to personal protective devices and more particularly pertains to a new personal protective device for a child. The present invention discloses personal protective device comprising a panel configured for engaging a head of a child, wherein the panel has either an integrated nipple or an aperture configured for insertion of a pacifying device.

### (2) Description of Related Art Including Information Disclosed Under 37 CFR 1.97 and 1.98

The prior art relates to personal protective devices. Prior art personal protective devices may comprise facial masks with integral nipples or pacifiers, and facial masks with insertion holes. What is lacking in the prior art is a protective device for a child, comprising a panel configured for engaging a head of a child, wherein the panel has either an integrated nipple or an aperture configured for insertion of a pacifying device, such as a sucker.

### BRIEF SUMMARY OF THE INVENTION

An embodiment of the disclosure meets the needs presented above by generally comprising a panel, which is configured to be attached to a head of a child so that the panel is positioned over at least a mouth and a nose of the child. The panel is configured to reduce transmission of pathogens between the child and persons proximate to the child. A pacifying element is engaged to the panel and is positioned proximate to the mouth of the child. The pacifying element is configured to facilitate pacification of the child, thus increasing a likelihood that the panel will remain in position on the head of the child.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a rear isometric perspective view of a pacifying personal protective device according to an embodiment of the disclosure.

FIG. 2 is a front view of an embodiment of the disclosure.

FIG. 3 is a rear view of an embodiment of the disclosure.

FIG. 4 is a cross-sectional view of an embodiment of the disclosure.

FIG. 5 is an in-use view of an embodiment of the disclosure.

FIG. 6 is a cross-sectional in-use view of an embodiment of the disclosure.

FIG. 7 is a rear isometric perspective view of an embodiment of the disclosure.

FIG. 8 is a front view of an embodiment of the disclosure.

FIG. 9 is a rear view of an embodiment of the disclosure.

FIG. 10 is a cross-sectional view of an embodiment of the disclosure.

FIG. 11 is a cross-sectional in-use view of an embodiment of the disclosure.

FIG. 12 is a rear isometric perspective view of an embodiment of the disclosure.

FIG. 13 is a rear isometric perspective view of an embodiment of the disclosure.

FIG. 14 is a flow diagram for a reduction and pacification method utilizing an embodiment of the disclosure.

FIG. 15 is a flow diagram for a reducing and pacifying method utilizing an embodiment of the disclosure.

### DETAILED DESCRIPTION OF THE INVENTION

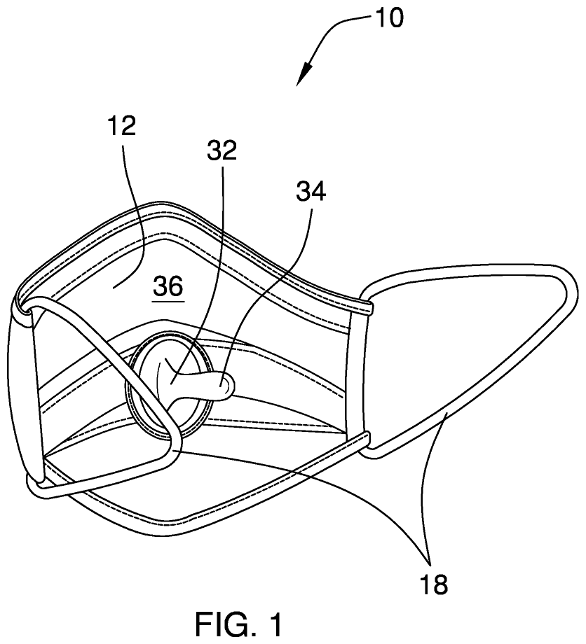

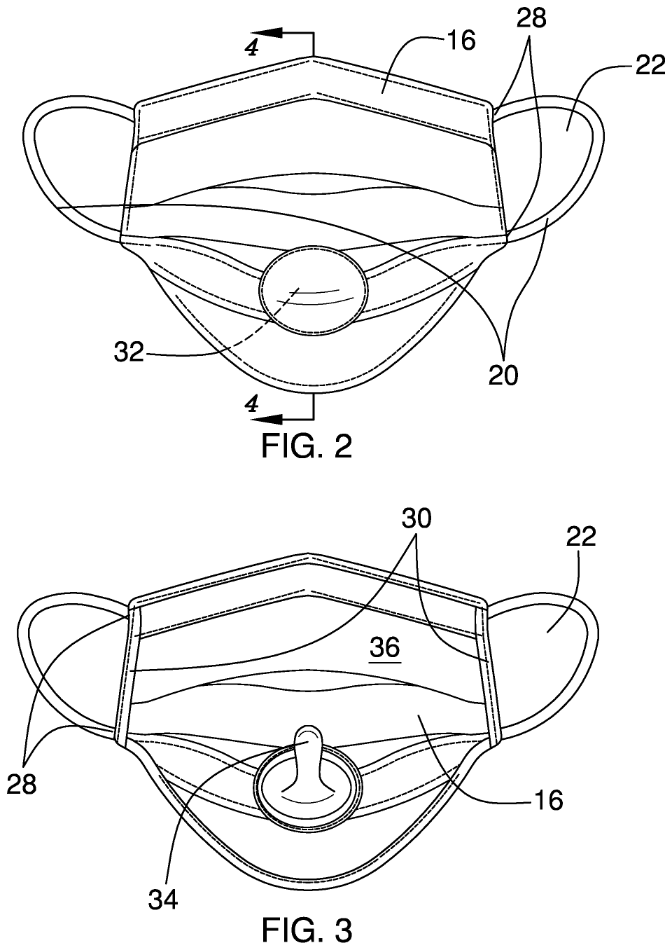

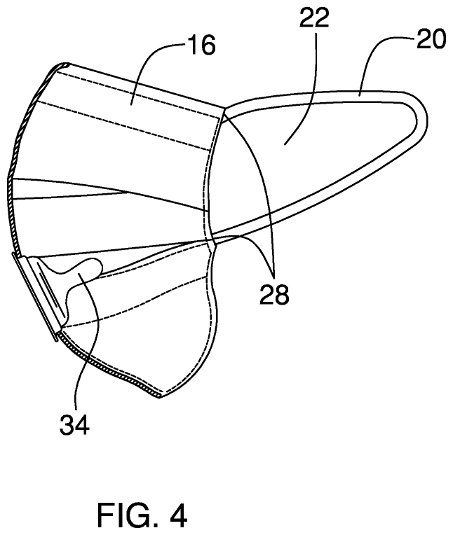

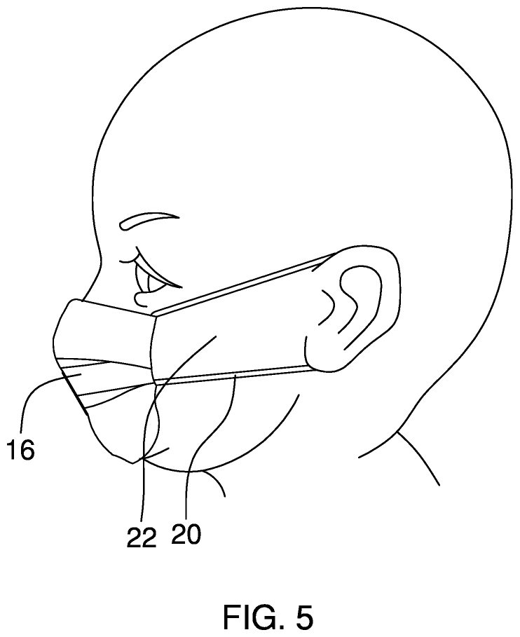

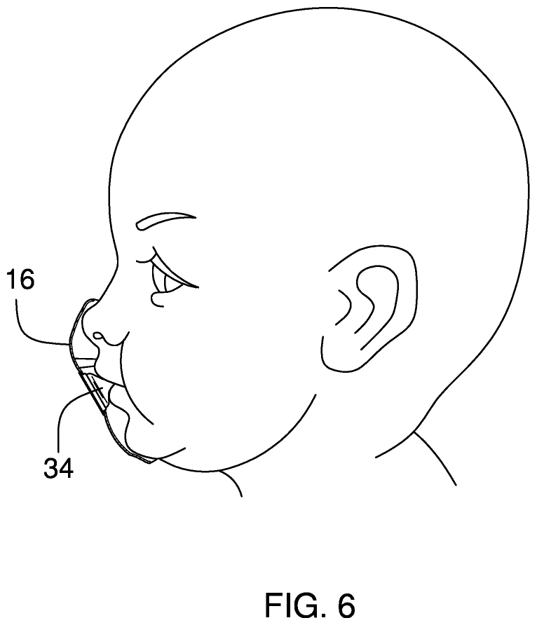

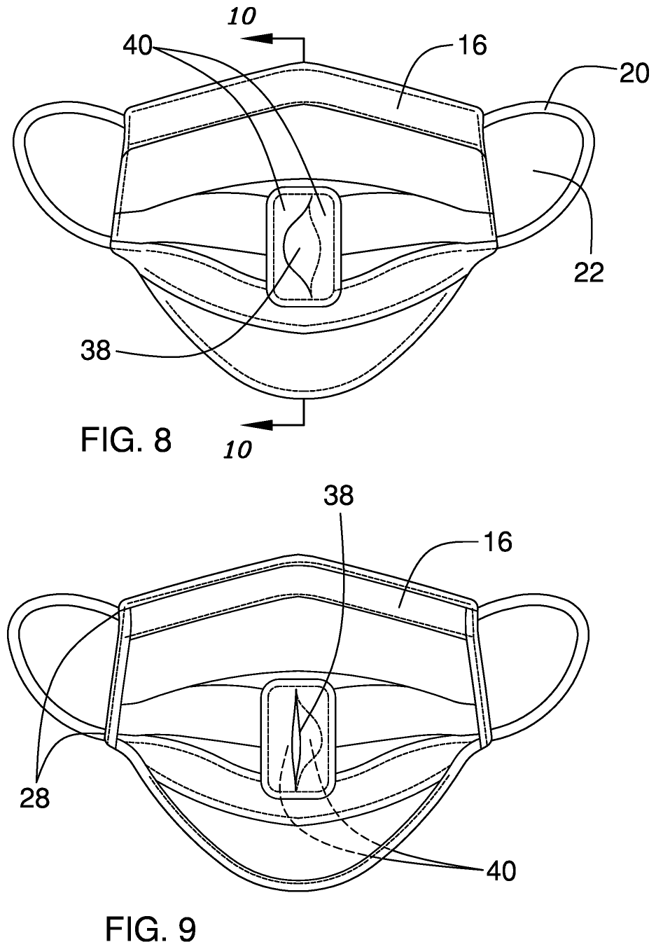

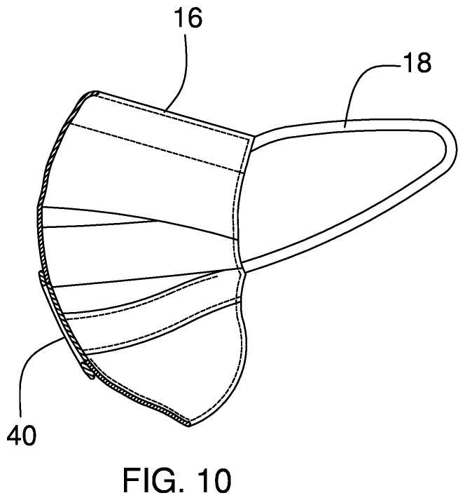

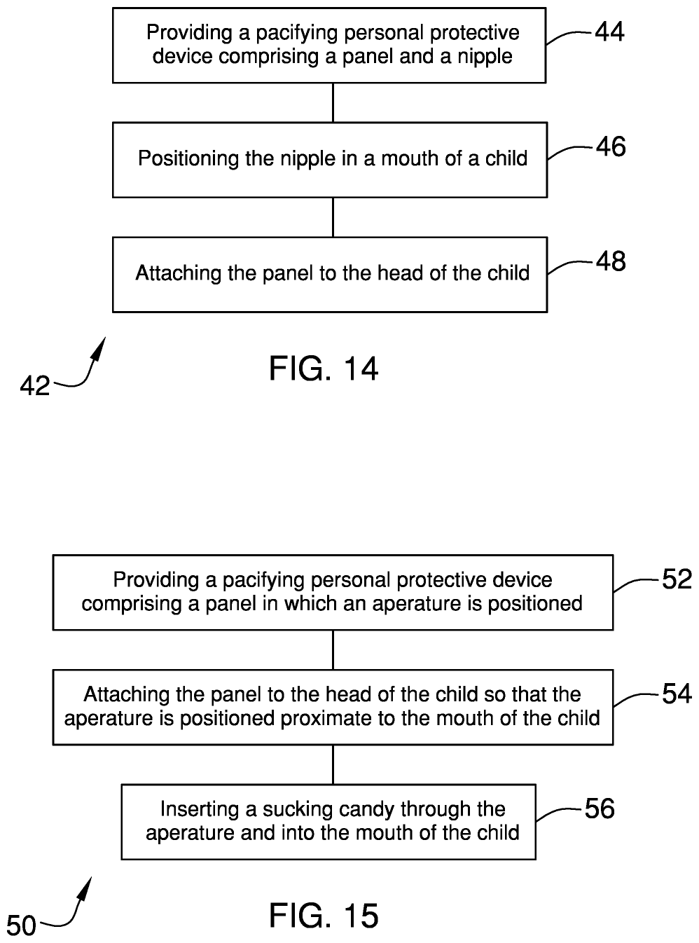

With reference now to the drawings, and in particular to FIGS. 1 through 15 thereof, a new personal protective device embodying the principles and concepts of an embodiment of the disclosure and generally designated by the reference numeral 10 will be described.

As best illustrated in FIGS. 1 through 15, the pacifying personal protective device 10 generally comprises a panel 12, which is configured to be attached to a head of a child so that the panel 12 is positioned over at least a mouth and a nose of the child. The panel 12 is configured to reduce transmission of pathogens between the child and persons proximate to the child. The panel 12 may comprise a face shield 14, a mask 16, a respirator (not shown), or the like.

A fastener 18 is engaged to the panel 12 and is configured to selectively engage the head of the child so that the panel 12 is removably engaged to the head of the child and positioned over at least the mouth and the nose of the child. The fastener 18 may comprise a set of bands 20, or other fastening means, such as, but not limited to, straps, ties, and the like. The bands 20 comprises elastic and thus are resiliently stretchable. Each band 20 defines a loop 22, which is configured to be positioned around a head or a respective ear of the child to removably engage the panel 12 to the head of the child.

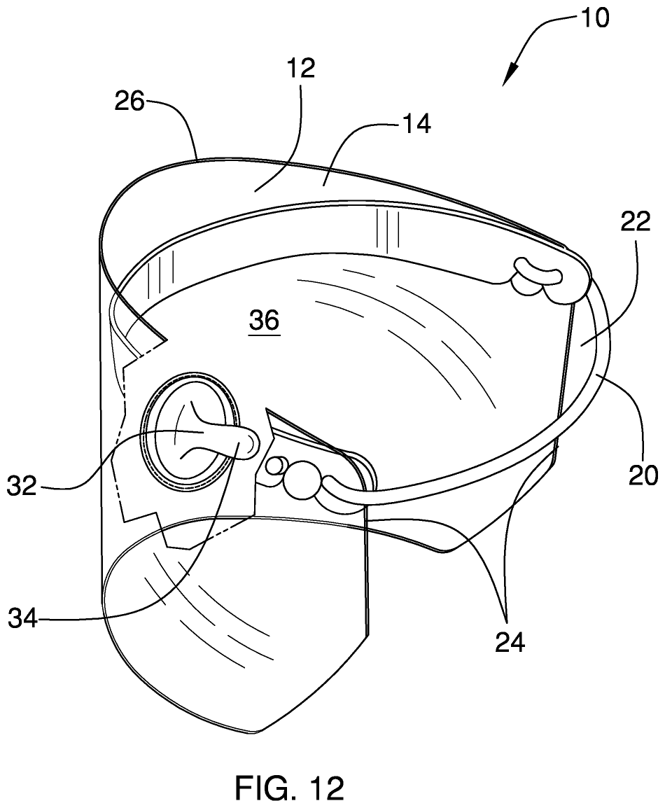

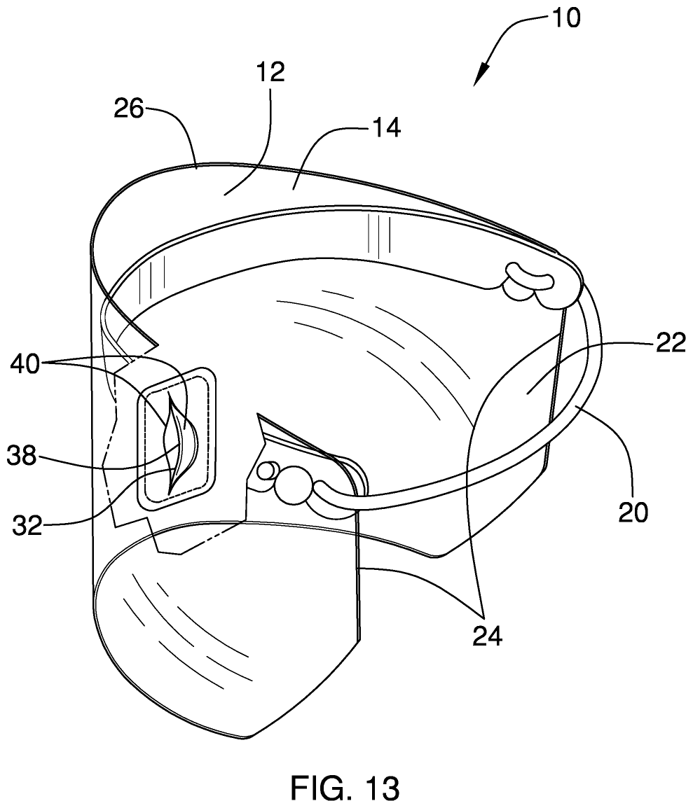

As shown in FIGS. 12 and 13, wherein the panel 12 comprises a face shield 14, the set of bands 20 comprises one band 20 engaged to and extending between opposed side edges 24 of the face shield 14 proximate to an upper rim 26 of the face shield 14. The band 20 is configured to be stretched to position the head of the child between the band 20 and the upper rim 26 so that the face shield 14 is frictionally engaged to the head of the child upon rebounding of the band 20.

As shown in FIGS. 1-11, wherein the panel 12 comprises a mask 16, the set of bands 20 comprises two bands 20. Each band 20 has opposed ends 28 engaged to a respective opposing side 30 of the mask 16 defining a loop 22. The band 20 is configured to be stretched to position a respective ear of the child into the loop 22 so that the mask 16 is engaged to the head of the child upon rebounding of the band 20.

A pacifying element 32 is engaged to the panel 12 and is positioned proximate to the mouth of the child. The pacifying element 32 is configured to facilitate pacification of the child, thus increasing a likelihood that the panel 12 will remain in position on the head of the child.

The pacifying element 32 may comprise a nipple 34, as shown in FIGS. 1-6 and 12. The nipple 34 is engaged to and which extends from an inner surface 36 of the panel 12. The nipple 34 is configured to be sucked upon by the child to pacify the child, particularly infants and toddlers.

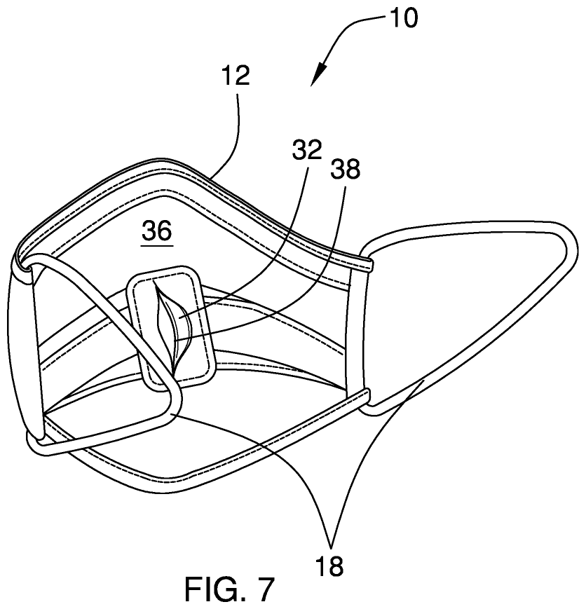

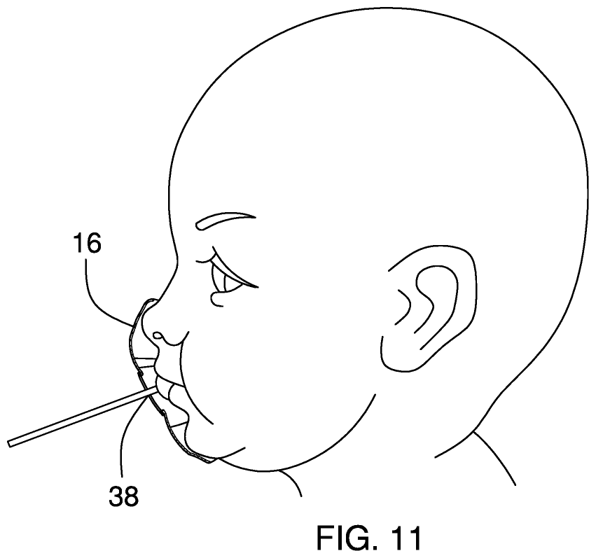

The pacifying element 32 also may comprise an aperture 38, as shown in FIGS. 7-11 and 13. The aperture 38 is positioned in the panel 12 and is configured for insertion of a sucking candy, such as a sucker, so that the sucking candy enters the mouth of the child to pacify the child, particularly children older than toddlers but still resistant to wearing a panel 12. A pair of flaps 40 is engaged to the panel 12 proximate to the aperture 38 so that the flaps 40 extend over the aperture 38. The flaps 40 are resiliently deformable. The pair of the flaps 40 is configured to be separated for insertion of the sucking candy through the aperture 38 into the mouth of the child, as shown in FIG. 11. The flaps 40 help to seal the aperture 38 after insertion of the sucking candy.

In use, the pacifying personal protective device 10 enables a pathogen transmission reduction and child pacification method 42. The reduction and pacification method 42 comprises a first step 44 of providing a pacifying personal protective device 10 comprising a panel 12 and a nipple 34. The panel 12 is configured to be attached to a head of a child so that the panel 12 is positioned over at least a mouth and a nose of the child. The nipple 34 is engaged to and extends from an inner surface 36 of the panel 12. A second step 46 of the reduction and pacification method 42 is positioning the nipple 34 in the mouth of the child. The nipple 34 is configured to be sucked upon by the child to pacify the child. A third step 48 of the reduction and pacification method 42 is attaching the panel 12 to the head of the child. The panel 12 is configured to reduce transmission of pathogens between the child and persons proximate to the child.

The pacifying personal protective device 10 also enables a pathogen transmission reducing and child pacifying method 50. The reducing and pacifying method 50 comprise a first step 52 of providing a pacifying personal protective device comprising a panel 12 in which an aperture 38 is positioned. The panel 12 is configured to be attached to a head of a child so that the panel 12 is positioned over at least a mouth and a nose of the child. A second step 54 of the reducing and pacifying method 50 is attaching the panel 12 to the head of the child so that the aperture 38 is positioned proximate to the mouth of the child. The panel 12 is configured to reduce transmission of pathogens between the child and persons proximate to the child. A third step 56 of the reducing and pacifying method 50 is inserting a sucking candy through the aperture 38 so that the sucking candy enters the mouth of the child to pacify the child.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pacifying personal protective device comprising:
a panel configured for attaching to a head of a child, such that the panel is positioned over at least a mouth and a nose of the child, wherein the panel is configured for reducing transmission of pathogens between the child and persons proximate to the child; and
a pacifying element engaged to the panel, such that the pacifying element is positioned proximate to the mouth of the child, wherein the pacifying element is configured for facilitating pacification of the child.

2. The pacifying personal protective device of claim 1, wherein the panel comprises a face shield, a mask, or a respirator.

3. The pacifying personal protective device of claim 1, further including a fastener engaged to the panel, the fastener being configured for selectively engaging the head of the child, such that the panel is removably engaged to the head of the child and positioned over at least the mouth and the nose of the child.

4. The pacifying personal protective device of claim 3, wherein the fastener comprises a set of bands, the bands being resiliently stretchable, each band defining a loop, wherein the loop is configured for positioning around a head or a respective ear of the child for removably engaging the panel to the head of the child.

5. The pacifying personal protective device of claim 4, wherein the bands comprising elastic.

6. The pacifying personal protective device of claim 4, wherein:
the panel comprises a face shield; and
the set of bands comprises one band engaged to and extending between opposed side edges proximate to an upper rim of the face shield, wherein the band is configured for stretching for positioning the head of the child between the band and the upper rim, such that the face shield is frictionally engaged to the head of the child upon rebounding of the band.

7. The pacifying personal protective device of claim 4, wherein:
the panel comprises a mask; and
the set of bands comprises two bands, each band having opposed ends engaged to a respective opposing side of the mask defining a loop, wherein the band is configured for stretching for positioning a respective ear of the child into the loop, such that the mask is engaged to the head of the child upon rebounding of the band.

8. The pacifying personal protective device of claim 1, wherein the pacifying element comprises a nipple, the nipple being engaged to and extending from an inner surface of the panel, wherein the nipple is configured for being sucked upon by the child for pacifying the child.

9. The pacifying personal protective device of claim 1, wherein the pacifying element comprises an aperture positioned in the panel, wherein the aperture is configured for insertion of a sucking candy, such that the sucking candy enters the mouth of the child for pacifying the child.

10. The pacifying personal protective device of claim 9, further including a pair of flaps engaged to the panel proximate to the aperture, such that the flaps extend over the aperture, the flaps being resiliently deformable, wherein pair of the flaps is configured for separating for insertion of the sucking candy through the aperture into the mouth of the child.

11. A pathogen transmission reduction and child pacification method, the reduction and pacification method comprising the steps of:
providing a pacifying personal protective device comprising:
a panel configured for attaching to a head of a child, such that the panel is positioned over at least a mouth and a nose of the child, and
a nipple engaged to and extending from an inner surface of the panel;
positioning the nipple in the mouth of the child, wherein the nipple is configured for being sucked upon by the child for pacifying the child; and
attaching the panel to the head of the child, wherein the panel is configured for reducing transmission of pathogens between the child and persons proximate to the child.

12. The pathogen transmission reduction and child pacification method of claim 11, further including:
the panel comprising a face shield; and
a set of bands comprising one band engaged to and extending between opposed side edges proximate to an upper rim of the face shield, wherein the band is configured for stretching for positioning the head of the child between the band and the upper rim, such that the face shield is frictionally engaged to the head of the child upon rebounding of the band.

13. The pathogen transmission reduction and child pacification method of claim 11, further including:
the panel comprising a mask; and
a set of bands comprising two bands, each band having opposed ends engaged to a respective opposing side of the mask defining a loop, wherein the band is configured for stretching for positioning a respective ear of the child into the loop, such that the mask is engaged to the head of the child upon rebounding of the band.

14. A pathogen transmission reducing and child pacifying method, the reducing and pacifying method comprising the steps of:
providing a pacifying personal protective device comprising:
a panel configured for attaching to a head of a child, such that the panel is positioned over at least a mouth and a nose of the child, and
an aperture positioned in the panel;
attaching the panel to the head of the child, such that the aperture is positioned proximate to the mouth of the child, wherein the panel is configured for reducing transmission of pathogens between the child and persons proximate to the child; and
inserting a sucking candy through the aperture, such that the sucking candy enters the mouth of the child for pacifying the child.

15. The pathogen transmission reducing and child pacifying method of claim 14, further including:
the panel comprising a face shield; and
a set of bands comprising one band engaged to and extending between opposed side edges proximate to an upper rim of the face shield, wherein the band is configured for stretching for positioning the head of the child between the band and the upper rim, such that the face shield is frictionally engaged to the head of the child upon rebounding of the band.

16. The pathogen transmission reducing and child pacifying method of claim 14, further including:
the panel comprising a mask; and
a set of bands comprising two bands, each band having opposed ends engaged to a respective opposing side of the mask defining a loop, wherein the band is configured for stretching for positioning a respective ear of the child into the loop, such that the mask is engaged to the head of the child upon rebounding of the band.
